(19) United States
(12) Patent Application Publication
(10) Pub. No.: US 2026/0309892 A1
(43) Pub. Date: Oct. 8, 2026

(54) Atmosphere-land-reservoir-river integrated medium-to-long-term chained-process runoff forecasting method

(71) Applicants: Bureau of Hydrology, Changjiang Water Resources Commission, Wuhan (CN); Mid-route Source of South-to-North Water Transfer Corp. Ltd, Shiyan (CN); Hanjiang Water Resources and Hydropower (Group) Co., Ltd, Wuhan (CN)

(72) Inventors: Wenjing NIU, Wuhan (CN); Yubin CHEN, Wuhan (CN); Baofei FENG, Wuhan (CN); Hongliang DING, Wuhan (CN); Yunqiao YUAN, Shiyan (CN); Zhengyou CHEN, Shiyan (CN); Yurong LI, Wuhan (CN); Fuqiang DONG, Wuhan (CN); Yinshan XU, Wuhan (CN); Dongdong CUI, Shiyan (CN); Bo XU, Shiyan (CN); Wei WANG, Wuhan (CN); Zhongkai FENG, Wuhan (CN); Xuan DONG, Wuhan (CN); Zhenghua WANG, Wuhan (CN)

(73) Assignees: Bureau of Hydrology, Changjiang Water Resources Commission, Wuhan (CN); Mid-route Source of South-to-North Water Transfer Corp. Ltd, Shiyan (CN); Hanjiang Water Resources and Hydropower (Group) Co., Ltd, Wuhan (CN)

(21) Appl. No.: 19/414,249

(22) Filed: Dec. 9, 2025

(30) Foreign Application Priority Data
Mar. 26, 2025 (CN) 202510364817.5

(51) Int. Cl. G01W 1/10; G06Q 10/04

(52) U.S. Cl. CPC G01W 1/10; G06Q 10/04

(57) ABSTRACT

An atmosphere-land-reservoir-river integrated medium-to-long-term chained-process runoff forecasting method includes: determining control sections and controlling reservoirs according to hydrological and meteorological characteristics of a study area, and constructing and decomposing a rainfall, runoff generation, confluence, and routing integrated chained-process forecasting framework into four modules: meteorological rainfall, land surface runoff generation, river channel confluence, and runoff routing; selecting applicable calculation models for each module according to an intended time scale for calculation, performing calculations of rainfall, runoff generation, confluence, and routing respectively through a hybrid downscaling model, a land surface runoff generation calculation equation, a river channel confluence calculation method, and a runoff routing equation considering an impact of reservoir operation, and acquiring runoff processes of different control sections; and sequentially performing runoff process calculations at different time scales, and concatenating the runoff process calculations into an atmosphere-land-reservoir-river integrated medium-to-long-term runoff calculation result of the study area.

### CROSS REFERENCE TO THE RELATED APPLICATIONS

This application is based upon and claims priority to Chinese Patent Application No. 202510364817.5, filed on Mar. 26, 2025, the entire contents of which are incorporated herein by reference.

### TECHNICAL FIELD

The present disclosure relates to the technical field of hydrology and water resource forecasting, and in particular to an atmosphere-land-reservoir-river integrated medium-to-long-term chained-process runoff forecasting method.

### BACKGROUND

Medium-to-long-term runoff forecasting is an important supporting tool in fields such as water resources management, flood control and drought relief, energy planning, and ecological restoration. With the intensification of global climate change and human activities, the contradiction between the supply and demand of water resources has become increasingly prominent, and accurate and reliable medium-to-long-term runoff forecasting has become particularly important. Accurate medium-to-long-term runoff forecasting can not only provide a scientific basis for reservoir operation, agricultural irrigation, power generation planning and others, but also offer strong support for regional water resources allocation and decision-making for flood control and disaster reduction. Especially against the background of frequent extreme weather events, the uncertainty analysis and risk assessment of medium-to-long-term runoff forecasting have important practical significance.

However, the accuracy and reliability of current medium-to-long-term runoff forecasting still has considerable room for improvement. Conventional statistical-based forecasting methods and hydrological models often show significant limitations when facing complex hydrological processes and nonlinear changes. On one hand, conventional methods cannot sufficiently describe the physical mechanisms of hydrological processes, making them unable to capture the long-term impacts of climate change and human activities on runoff. On the other hand, with the introduction of machine learning technologies, although the forecasting accuracy has been improved to a certain extent, the stability and applicability of forecasting in complex hydrological environments still need to be verified. In addition, existing forecasting methods have weak ability to fuse multi-source data and are unable to fully utilize multi-dimensional data such as meteorological, remote sensing, and hydrological data, which further restricts the improvement of forecasting accuracy.

In summary, medium-to-long-term runoff forecasting plays an irreplaceable role in water resources management and socio-economic development, but its insufficient accuracy and method limitations are still the current research difficulties. By improving forecasting methods, optimizing model structures, enhancing data utilization efficiency, and strengthening research on the impacts of climate change, the accuracy and reliability of medium-to-long-term runoff forecasting can be significantly improved. This can provide a more solid technical support for the sustainable management of water resources.

### SUMMARY

To address the aforementioned deficiencies of the prior art, an objective of the present disclosure is to provide an atmosphere-land-reservoir-river integrated medium-to-long-term chained-process runoff forecasting method. The present disclosure starts with four processes: rainfall, runoff generation, confluence, and routing. Based on the characteristics of rainfall forecasting, runoff generation calculation, confluence calculation, and runoff routing processes, the present disclosure proposes a selection basis of calculation models and a result coupling method to improve the accuracy of medium-to-long-term runoff forecasting.

To achieve the above objective, the present disclosure adopts the following technical solution:

The present disclosure provides an atmosphere-land-reservoir-river integrated medium-to-long-term chained-process runoff forecasting method, including:
S1: selecting a study area, determining control sections and controlling reservoirs, and acquiring and organizing long-series historical meteorological and hydrological data:
meteorological data of the control sections: A_{f} {a₁, a₂, a₃, . . . , aᵢ, . . . , a_{N}};
hydrological data of the control sections: H_{f}={h₁, h₂, h₃, . . . ,hᵢ, . . . ,h_{N}};
meteorological data of the controlling reservoirs: Aᵣ={b₁, b₂, b₃, . . . , bⱼ, . . . , b_{M}}; and
hydrological data of the controlling reservoirs: Hᵣ {l₁, l₂, l₃, . . . , lⱼ, . . . , l_{M}};
where, A_{f} denotes the meteorological data of the control sections; aᵢ denotes the meteorological data of an i-th control section; H_{f} denotes the hydrological data of the control sections; hᵢ denotes the hydrological data of the i-th control section; N denotes a number of the control sections; Aᵣ denotes the meteorological data of the controlling reservoirs; bⱼ denotes the meteorological data of a j-th controlling reservoir; Hᵣ denotes the hydrological data of the controlling reservoirs; lⱼ denotes the hydrological data of the j-th controlling reservoir; and M denotes a number of the controlling reservoirs;
S2: establishing a rainfall, runoff generation, confluence, and routing integrated chained-process forecasting framework, and performing series calculations through a meteorological rainfall module R(r₁, r₂, . . . , rₓ), a land surface runoff generation module Q(R, S, Pa, M), a river channel confluence module M (Q, L, G, X), and a runoff routing module E(M, L, G, O, Y);
where, R(r₁, r₂, . . . , rₓ) denotes a rainfall calculation equation, and rₓ denotes different factors affecting a rainfall value;
Q(R, S, Pa, M) denotes a runoff generation calculation equation; R denotes the rainfall value; S denotes a catchment area of a basin; Pa denotes an antecedent precipitation index; and M denotes a runoff generation mode, including saturation excess runoff generation and infiltration excess runoff generation;
M(Q, L, G, X) denotes a confluence calculation equation; Q denotes a runoff generation value; L denotes a length of a confluence river channel; G denotes a slope of the confluence river channel; and X denotes a factor affecting confluence; and
E(M, L, G, O, Y) denotes a routing calculation equation; M denotes a confluence value; O denotes a regulation and storage impact of reservoirs during a routing process; and Y denotes a factor affecting routing;
S3: constructing a hybrid downscaling model R′ in the meteorological rainfall module, and performing medium-to-long-term rainfall forecasting in the study area;
S4: performing, by taking a rainfall forecast as an input in the land surface runoff generation module, runoff generation calculations for control sections corresponding to different zones in the study area through a hydrological model, assuming Sₘ is an M-th zone of the study area, with a runoff yield of Qₘ=Γ(Sₘ), where Γ(Sₘ) denotes a runoff generation calculation equation for the m-th zone;
S5: performing, by combining an isochrone method, a time-interval unit hydrograph method and an instantaneous unit hydrograph method, a river channel confluence calculation in the river channel confluence module to acquire discharge processes of different control sections;
S6: performing, by a Muskingum method, a composite discharge method and a hydrodynamic method, a river channel routing calculation in the runoff routing module to acquire discharge processes of different control sections after river channel routing;
S7: performing sequential routing calculations for each node from upstream to downstream according to a same time scale until runoff processes of the control sections at the same time scale are output; and
S8: completing runoff process calculations for the study area at different time scales, including ten-day, monthly, seasonal, and annual.

Furthermore, in the step S1, a method for determining the control sections and the controlling reservoirs includes: selecting a section where an important flood control protection object is located and a concerned section as control sections, and selecting reservoirs with a flood control capacity greater than or equal to 100 million m³ or a total storage capacity ranking among top 5-10% of all reservoirs in the basin as controlling reservoirs, based on a condition of the flood control protection object in the study area, sections to be forecasted, and reservoirs with a large total storage capacity and a regulatory capacity in the basin, and on the premise of ensuring flood control safety of the basin.

Furthermore, in the step S1, the meteorological data includes rainfall, air temperature, wind speed, and radiation; and
the hydrological data includes discharge, water level, evaporation, reservoir water level, reservoir inflow, and reservoir outflow.

Furthermore, in the step S3, the medium-to-long-term rainfall forecasting includes: medium-term rainfall forecasting for taking ten-day as a calculation scale and outputting daily rainfall in an area above each control section; and long-term rainfall forecasting for taking monthly, seasonal, and annual as calculation scales and outputting monthly rainfall in the area above each control section.

Furthermore, in the step S3, the hybrid downscaling model refers to a medium-to-long-term rainfall forecasting model constructed by coupling dynamic downscaling, statistical downscaling, and artificial intelligence, and is specifically configured to perform following steps:
S301: acquiring output data

$${R}_{out}^{k} ( k = 1 , 2 , … , K )$$

of different global climate models, where

$${R}_{out}^{k}$$

denotes rainfall output data of a k-th global climate model, and K denotes a number of types of global climate models participating in a calculation; comparing and analyzing the output data with measured data

$${R}_{{A}_{f}}^{k}$$

of the study area; evaluating forecasting accuracy P^{k} of different global climate models; and sorting availability of different global climate models in descending order of the forecasting accuracy, where

$${P}^{k} = \frac{{P}_{{A}_{f}}^{k} + {P}_{{A}_{r}}^{k}}{2} ;$$

P^{k} denotes the forecasting accuracy of the k-th global climate model;

$${P}_{{A}_{f}}^{k}$$

denotes the forecasting accuracy of the control section in the k-th global climate model; and

$${P}_{{A}_{r}}^{k}$$

denotes the forecasting accuracy of the controlling reservoir in the k-th global climate model;
S302: selecting one or multiple global climate models with high availability according to an evaluation result in combination with a characteristic of the study area; setting an initial condition and a boundary condition, and performing simulation operation; and acquiring a regional climate model with a good forecasting effect for the study area;
where, if one global climate model is selected, a calculation result

$${R}_{out}^{{k}^{′}}$$

of the regional climate model is equal to the output data

$${R}_{out}^{k}$$

of the global climate model; and
if multiple global climate models are selected, the calculation result

$${R}_{out}^{{k}^{′′}}$$

of the regional climate model is equal to an arithmetic mean of calculation results of the multiple global climate models:

$${R}_{out}^{{k}^{′′}} = \frac{{R}_{out}^{1} + {R}_{out}^{2} + … + {R}_{out}^{k}}{k} ;$$

S303: analyzing a simulation result, and evaluating an error in the global climate models; and fitting an error distribution law through an artificial intelligence algorithm based on deep learning, and acquiring an error correction calculation equation e(x), where e denotes error correction data; and x denotes a matrix including a factor affecting the error distribution law; and
S304: performing medium-to-long-term rainfall forecasting for the study area through the regional climate model; and revising a forecasting result based on the error correction calculation equation, and outputting the revised forecasting result as a final rainfall forecasting result,

$${R}_{out}^{all} = {R}_{out}^{{k}^{′}} + e .$$

Furthermore, in the step S4, the hydrological model includes a Xinanjiang model, a rainfall-runoff correlation graph, a Sacramento (SAC) model, a soil and water assessment tool (SWAT) model, a topography-based model of landscape evolution (TOPMODEL), and a hydrological model suitable for a runoff calculation above the monthly scale;
where, the SAC model is a basin hydrological model, a hydrological model configured to simulate a basin hydrological process, mainly for rainfall-runoff forecasting, converting rainfall into a surface runoff and a groundwater runoff by simulating a change in soil moisture;
the SWAT model is a geographic information system (GIS)-based distributed basin hydrological model, configured to simulate various hydrological, physical, and chemical processes through spatial information provided by remote sensing and geographic information systems;
the TOPMODEL is a terrain-based distributed hydrological model, mainly configured to simulate surface runoff, water movement, and basin hydrological processes; and the above three models are all mature and well-known common sense models in the field of hydrological forecasting; and
the runoff generation calculations include: a medium-term runoff generation calculation within the ten-day scale: performing a calculation through the Xinanjiang model, the rainfall-runoff correlation graph, the SAC model, the SWAT model, and the TOPMODEL according to a climate zone and a runoff generation characteristic of the study area, and outputting a daily runoff forecast; and
a long-term runoff generation calculation at the monthly scale and above: performing a calculation through the SWAT model, the TOPMODEL, and the hydrological model suitable for the runoff calculation above the monthly scale, and outputting a monthly runoff forecast.

Furthermore, in the step S5, when the river channel confluence calculation is performed, the isochrone method is adopted in case of a non-uniform rainfall areal distribution in the study area;
the time-interval unit hydrograph method is adopted in case of a uniform rainfall spatiotemporal distribution during a calculation period and a short net rainfall duration; and
the instantaneous unit hydrograph method is adopted in case of an obvious runoff change process predicted during the calculation period and a uniformly distributed net rainfall intensity within a unit time interval.

Furthermore, in the step S6, when the river channel routing calculation is performed, the Muskingum method is adopted in case of a straight river channel and a linear discharge change along a course;
the composite discharge method is adopted in case of a short river channel routing length and many tributary inflows; and
the hydrodynamic method is adopted in case of a complex river channel terrain and a nonlinear discharge change along the course.

Furthermore, the method includes at least one processor and a memory communicatively connected to the at least one processor, where
the memory is configured to store an instruction executable by the processor; and the instruction is executed by the processor to implement the atmosphere-land-reservoir-river integrated medium-to-long-term chained-process runoff forecasting method.

The present disclosure has the following beneficial effects. First, the present disclosure determines the control sections and controlling reservoirs (group) according to the hydrometeorological characteristics of the study area, constructs the rainfall, runoff generation, confluence, and routing integrated chained-process forecasting framework, and decomposes it into four modules: meteorological rainfall, land surface runoff generation, river channel confluence, and runoff routing. Then, the present disclosure selects applicable calculation models for each module according to the intended time scale for calculation, and respectively completes the calculations of rainfall, runoff generation, confluence, and routing through the hybrid downscaling model, land surface runoff generation calculation equation, river channel confluence calculation method, and runoff routing equation considering the impact of reservoir (group) operation, so as to acquire the runoff processes of different control sections. Finally, the present disclosure sequentially carries out the calculation of runoff processes at different time scales and concatenates them into the atmosphere-land-reservoir-river integrated medium-to-long-term runoff calculation result of the study area. The present disclosure can effectively improve the accuracy of medium-to-long-term runoff forecasting and provide important technical support for the optimal allocation and efficient utilization of water resources in the basin.

### BRIEF DESCRIPTION OF THE DRAWINGS

FIG. 1 is a flow chart of an atmosphere-land-reservoir-river integrated medium-to-long-term chained-process runoff forecasting method;

FIG. 2 is a schematic diagram of a system structure of the upper Hanjiang River basin in an embodiment, including a water system distribution map of the upper Hanjiang River and a schematic diagram of controlling reservoirs in the upper Hanjiang River;

FIG. 3 is a schematic diagram of rainfall zoning of the upper Hanjiang River basin system in the embodiment;

FIG. 4 is a schematic diagram of a runoff process at the Yangxian Station section in the embodiment;

FIG. 5 is a schematic diagram of a runoff process at the Ankang Station section in the embodiment;

FIG. 6 is a schematic diagram of inflow and outflow processes at the Shiquan Reservoir section in the embodiment;

FIG. 7 is a schematic diagram of inflow and outflow processes at the Ankang Reservoir section in the embodiment; and

FIG. 8 is a schematic diagram of inflow and outflow processes at the Danjiangkou Reservoir section in the embodiment.

### DETAILED DESCRIPTION OF THE EMBODIMENTS

To make the objectives, technical solutions, and advantages of the present disclosure clearer, the following describes the present disclosure in more detail with reference to the drawings.

It should be understood that the specific embodiments described herein are merely intended to explain the present disclosure, but not to limit the present disclosure.

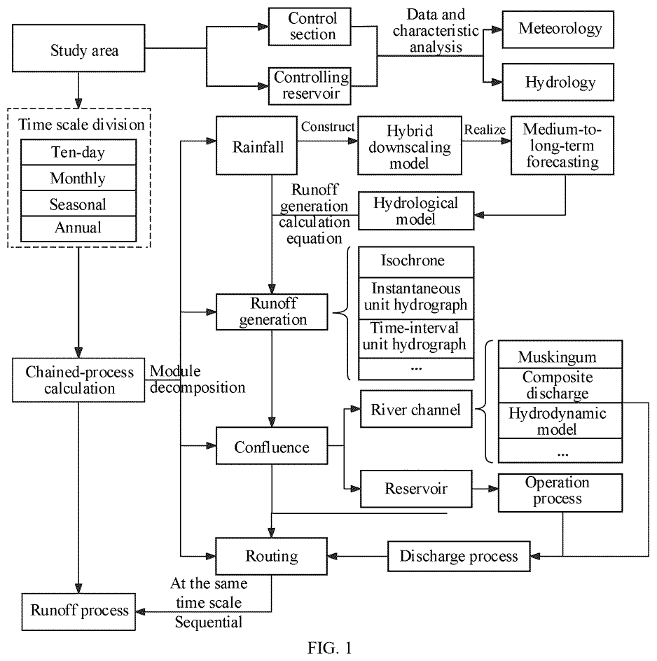

As shown in FIG. 1, an atmosphere-land-reservoir-river integrated medium-to-long-term chained-process runoff forecasting method includes following steps.
S1. A study area is selected, control sections and controlling reservoirs are determined, and long-series historical meteorological and hydrological data are acquired and organized:
meteorological data of the control sections: A_{f}={a₁, a₂, a₃, . . . , aᵢ, . . . , a_{N}};
hydrological data of the control sections: H_{f}={h₁, h₂, h₃, . . . , hᵢ, . . . , h_{N}};
meteorological data of the controlling reservoirs: Aᵣ={b₁, b₂, b₃, . . . , bⱼ, . . . , b_{M}}; and
hydrological data of the controlling reservoirs: Hᵣ={l₁, l₂, l₃, . . . , lⱼ, . . . , l_{M}};
where, A_{f} denotes the meteorological data of the control sections; aᵢ denotes the meteorological data of an i-th control section; H_{f} denotes the hydrological data of the control sections; hᵢ denotes the hydrological data of the i-th control section; N denotes a number of the control sections; Aᵣ denotes the meteorological data of the controlling reservoirs; bⱼ denotes the meteorological data of a j-th controlling reservoir; Hᵣ denotes the hydrological data of the controlling reservoirs; lⱼ denotes the hydrological data of the j-th controlling reservoir; and M denotes a number of the controlling reservoirs.
S2. A rainfall, runoff generation, confluence, and routing integrated chained-process forecasting framework is established, and series calculations are performed through meteorological rainfall module R(r₁, r₂, . . . , rₓ), land surface runoff generation module Q(R, S, Pa, M), river channel confluence module M(Q, L, G, X), and runoff routing module E(M, L, G, O, Y);
where, R(r₁, r₂, . . . , rₓ) denotes a rainfall calculation equation, and rₓ denotes different factors affecting a rainfall value;
Q(R, S, Pa, M) denotes a runoff generation calculation equation; R denotes the rainfall value; S denotes a catchment area of a basin; Pa denotes an antecedent precipitation index; and M denotes a runoff generation mode, including saturation excess runoff generation and infiltration excess runoff generation;
M(Q, L, G, X) denotes a confluence calculation equation; Q denotes a runoff generation value; L denotes a length of a confluence river channel; G denotes a slope of the confluence river channel; and X denotes a factor affecting confluence; and
E(M, L, G, O, Y) denotes a routing calculation equation; M denotes a confluence value; O denotes a regulation and storage impact of reservoirs during a routing process; and Y denotes a factor affecting routing.
S3. Hybrid downscaling model R′ is constructed in the meteorological rainfall module, and medium-to-long-term rainfall forecasting is performed in the study area.
S4. By taking a rainfall forecast as an input in the land surface runoff generation module, runoff generation calculations are performed for control sections corresponding to different zones in the study area through a hydrological model, assuming Sₘ is an m-th zone of the study area, with a runoff yield of Qₘ=Γ(Sₘ), where Γ(Sₘ) denotes a runoff generation calculation equation for the m-th zone.
S5. A river channel confluence calculation is performed in the river channel confluence module by combining an isochrone method, a time-interval unit hydrograph method and an instantaneous unit hydrograph method to acquire discharge processes of different control sections.
S6. A river channel routing calculation is performed in the runoff routing module by a Muskingum method, a composite discharge method and a hydrodynamic method to acquire discharge processes of different control sections after river channel routing.
S7. Sequential routing calculations are performed for each node from upstream to downstream according to a same time scale until runoff processes of the control sections at the same time scale are output.
S8. Runoff process calculations are completed for the study area at different time scales, including ten-day, monthly, seasonal, and annual.

In the step S1, the control sections and the controlling reservoirs are determined by selecting a section where an important flood control protection object is located and a concerned section as control sections, and selecting reservoirs with a flood control capacity greater than or equal to 100 million m³ or a total storage capacity ranking among top 5-10% of all reservoirs in the basin as controlling reservoirs, based on a condition of the flood control protection object in the study area, sections to be forecasted, and reservoirs with a large total storage capacity and a regulatory capacity in the basin, and on the premise of ensuring flood control safety of the basin.

In the step S1, the meteorological data includes rainfall, air temperature, wind speed, and radiation; and
the hydrological data includes discharge, water level, evaporation, reservoir water level, reservoir inflow, and reservoir outflow.

In the step S3, the medium-to-long-term rainfall forecasting includes: medium-term rainfall forecasting for taking ten-day as a calculation scale and outputting daily rainfall in an area above each control section; and long-term rainfall forecasting for taking monthly, seasonal, and annual as calculation scales and outputting monthly rainfall in the area above each control section.

In the step S3, the hybrid downscaling model refers to a medium-to-long-term rainfall forecasting model constructed by coupling dynamic downscaling, statistical downscaling, and artificial intelligence, is specifically configured to perform following steps.
S301. Output data

$${R}_{out}^{k} ( k = 1 , 2 , … , K )$$

of different global climate models are acquired, where

$${R}_{out}^{k}$$

denotes rainfall output data of a k-th global climate model, and K denotes a number of types of global climate models participating in a calculation; comparing and analyzing the output data with measured data

$${R}_{{A}_{f}}^{k}$$

of the study area; evaluating forecasting accuracy P^{k} of different global climate models; and sorting availability of different global climate models in descending order of the forecasting accuracy, where

$${P}^{k} = \frac{{P}_{{A}_{f}}^{k} + {P}_{{A}_{r}}^{k}}{2} ;$$

P^{k} denotes the forecasting accuracy of the k-th global climate model;

$${P}_{{A}_{f}}^{k}$$

denotes the forecasting accuracy of the control section in the k-th global climate model; and

$${P}_{{A}_{r}}^{k}$$

denotes the forecasting accuracy of the controlling reservoir in the k-th global climate model.
S302. One or multiple global climate models with high availability are selected according to an evaluation result in combination with a characteristic of the study area; an initial condition and a boundary condition are set, and simulation operation is performed; and a regional climate model with a good forecasting effect for the study area is acquired.

If one global climate model is selected, a calculation result

$${R}_{out}^{{k}^{′}}$$

of the regional climate model is equal to the output data

$${R}_{out}^{k}$$

of the global climate model.

If multiple global climate models are selected, the calculation result

$${R}_{out}^{k ″}$$

of the regional climate model is equal to an arithmetic mean of calculation results of the multiple global climate models:

$${R}_{o u t}^{k ″} = \frac{{R}_{o u t}^{1} + {R}_{o u t}^{2} + … + {R}_{o u t}^{k}}{k} .$$

S303. A simulation result is analyzed, and an error in the global climate models is evaluated; and an error distribution law is fitted through an artificial intelligence algorithm based on deep learning, and error correction calculation equation e(X) is acquired, where e denotes error correction data; and X denotes a matrix including a factor affecting the error distribution law.
S304. Medium-to-long-term rainfall forecasting is performed for the study area through the regional climate model; and a forecasting result is revised based on the error correction calculation equation, and the revised forecasting result is output as a final rainfall forecasting result,

$${R}_{o u t}^{a l l} = {R}_{o u t}^{k ′} + e .$$

In the step S4, the hydrological model includes a Xinanjiang model, a rainfall-runoff correlation graph, a Sacramento (SAC) model, a soil and water assessment tool (SWAT) model, a topography-based model of landscape evolution (TOPMODEL), and a hydrological model suitable for a runoff calculation above the monthly scale;
the runoff generation calculations include: a medium-term runoff generation calculation within the ten-day scale for performing a calculation through the Xinanjiang model, the rainfall-runoff correlation graph, the SAC model, the SWAT model, and the TOPMODEL according to a climate zone and a runoff generation characteristic of the study area, and outputting a daily runoff forecast; and
a long-term runoff generation calculation at the monthly scale and above for performing a calculation through the SWAT model, the TOPMODEL, and the hydrological model suitable for the runoff calculation above the monthly scale, and outputting a monthly runoff forecast.

In the step S5, when the river channel confluence calculation is performed, the isochrone method is adopted in case of a non-uniform rainfall areal distribution in the study area;
the time-interval unit hydrograph method is adopted in case of a uniform rainfall spatiotemporal distribution during a calculation period and a short net rainfall duration; and
the instantaneous unit hydrograph method is adopted in case of an obvious runoff change process predicted during the calculation period and a uniformly distributed net rainfall intensity within a unit time interval.

In the step S6, when the river channel routing calculation is performed, the Muskingum method is adopted in case of a straight river channel and a linear discharge change along a course;
the composite discharge method is adopted in case of a short river channel routing length and many tributary inflows; and
the hydrodynamic method is adopted in case of a complex river channel terrain and a nonlinear discharge change along the course.

The method includes at least one processor and a memory communicatively connected to the at least one processor; and
the memory is configured to store an instruction executable by the processor; and the instruction is executed by the processor to implement the atmosphere-land-reservoir-river integrated medium-to-long-term chained-process runoff forecasting method.

### EMBODIMENT

Taking the basin system with the Danjiangkou Reservoir as the core in the upper Hanjiang River as an example, the medium-to-long-term ten-day scale runoff forecasting calculation is carried out to verify the feasibility and effectiveness of the method of the present disclosure.

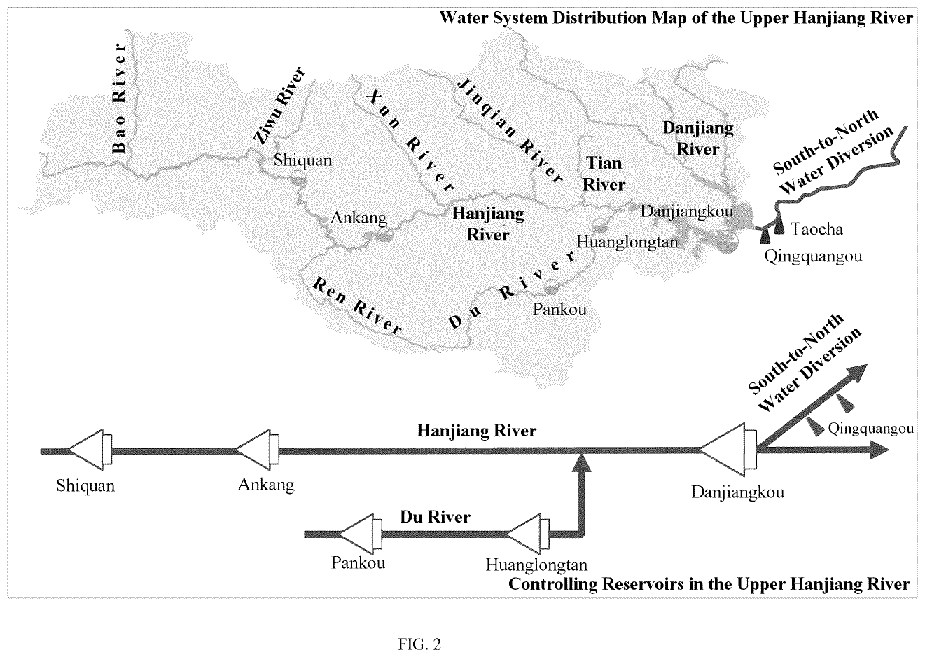

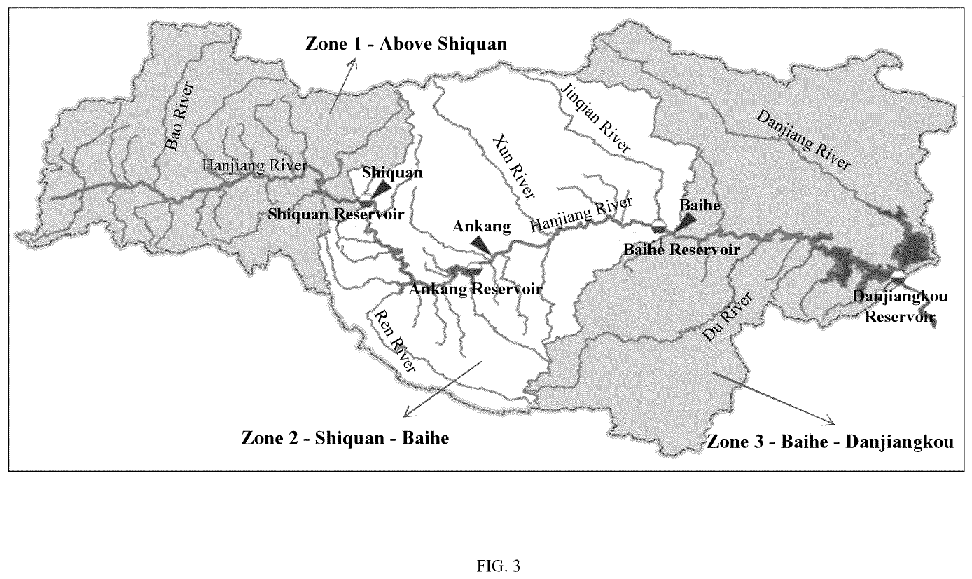

FIG. 2 and FIG. 3 depict the basin system and rainfall forecasting zoning of the upper Hanjiang River, respectively. It can be seen from FIG. 2 and FIG. 3 that the medium-to-long-term runoff forecasting of the upper Hanjiang River basin system is decomposed into a rainfall forecasting module for 3 zones, a multi-zone runoff generation module and a confluence module composed of different main and tributary rivers, and a river routing module with Shiquan Reservoir, Ankang Reservoir, Pankou Reservoir, Huanglongtan Reservoir, and Danjiangkou Reservoir as controlling reservoir nodes. When a rainfall process occurs in the basin, the method of the present disclosure first calculates the areal rainfall of the 3 zones through the hybrid downscaling model, and then respectively carries out the calculations of runoff generation, confluence, and routing. The method establishes the operation rules of the 5 reservoirs and performs reservoir operation to realize the continuous calculation of the river system until the inflow runoff process of the Danjiangkou Reservoir section is output as the ten-day scale (i.e., the next 10 days) runoff forecasting result of the upper Hanjiang River.

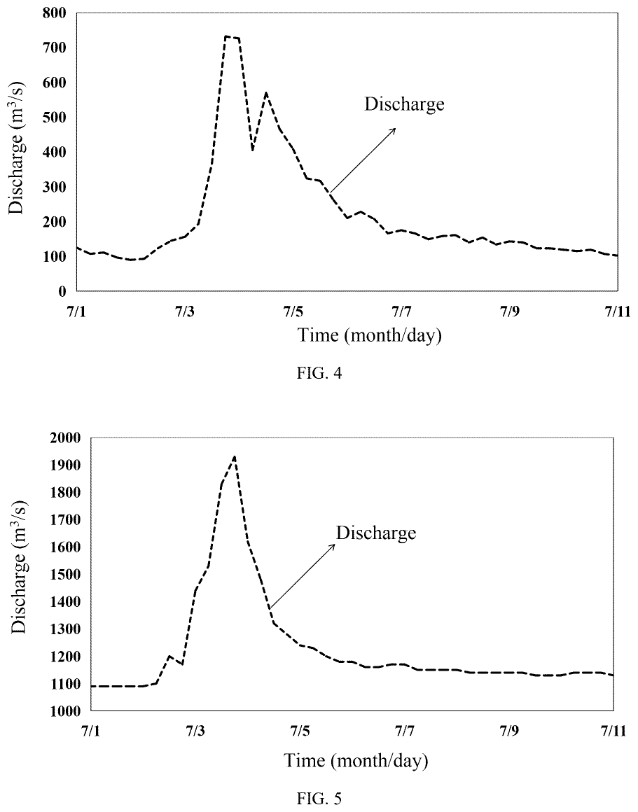

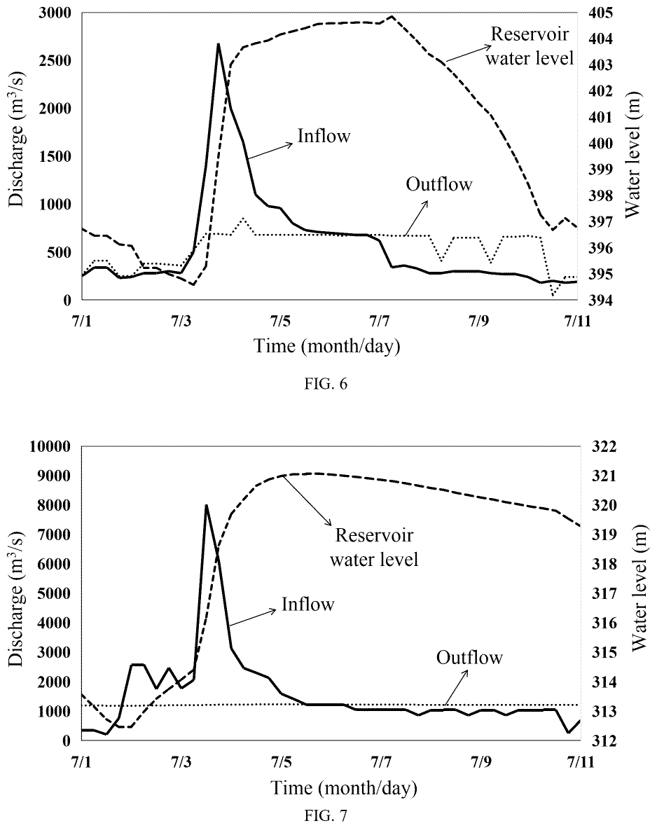

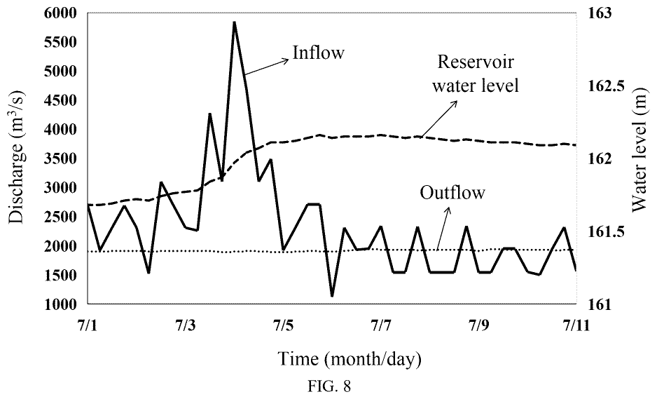

Table 1 shows the runoff results of the main control sections (Yangxian Station and Ankang Station) and the controlling reservoir section (Danjiangkou Reservoir), and the specific runoff processes of each section are shown in FIG. 4 to FIG. 7.

TABLE 1
Information table of specific operation processes of Section 1 to Section 3

| | | Section 1 - | Section 2 - | Section 3 - | | |
|---|---|---|---|---|---|---|
| | | Yangxian | Ankang | Danjiangkou Reservoir | | |
| | | Station | Station | Water | | Out- |
| No. | Time | Discharge | Discharge | level | Inflow | flow |
| 1 | 2023/7/1 8:00 | 125 | 1090 | 161.68 | 2700 | 1900 |
| 2 | 2023/7/2 8:00 | 89.7 | 1090 | 161.72 | 2310 | 1910 |
| 3 | 2023/7/3 8:00 | 156 | 1440 | 161.77 | 2310 | 1910 |
| 4 | 2023/7/4 8:00 | 726 | 1620 | 161.97 | 5850 | 1900 |
| 5 | 2023/7/5 8:00 | 408 | 1240 | 162.11 | 1920 | 1890 |
| 6 | 2023/7/6 8:00 | 210 | 1180 | 162.14 | 1120 | 1900 |
| 7 | 2023/7/7 8:00 | 175 | 1170 | 162.16 | 2340 | 1930 |
| 8 | 2023/7/8 8:00 | 161 | 1150 | 162.14 | 1540 | 1930 |
| 9 | 2023/7/9 8:00 | 143 | 1140 | 162.12 | 1540 | 1910 |
| 10 | 2023/7/10 8:00 | 119 | 1130 | 162.1 | 1550 | 1930 |

It can be seen from FIG. 4 to FIG. 7 that the atmosphere-land-reservoir-river integrated medium-to-long-term chained-process runoff forecasting method of the present disclosure can quickly realize the calculations of rainfall, runoff generation, confluence, and routing in the study area and acquire the medium-to-long-term runoff processes of the required sections. The forecasting results of the present disclosure have a good fitting effect with the actual processes, and the forecasting accuracy is significantly improved, which proves the feasibility and effectiveness of the proposed method. It can be concluded that the method of the present disclosure has superior application effects in medium-to-long-term runoff forecasting.

According to the above analysis, the method of the present disclosure has strong practicability and can effectively solve the problem of insufficient accuracy in medium-to-long-term runoff forecasting.

In summary, the present disclosure has the advantages of strong practicability and operability, can quickly realize the medium-to-long-term runoff forecasting of the study area, acquire the runoff forecasting results of important sections, and provide more scientific and efficient technical support for hydrology and water resources forecasting and reservoir operation of the basin.

The above embodiments are merely illustrative of some implementations of the present disclosure, and the description thereof is specific and detailed, but should not be construed as limiting the patent scope of the present disclosure. It should be noted that those of ordinary skill in the art can further make several variations and improvements without departing from the concept of the present disclosure, and all of these fall within the protection scope of the present disclosure. Therefore, the protection scope of the present disclosure should be subject to the appended claims.

1. An atmosphere-land-reservoir-river integrated medium-to-long-term chained-process runoff forecasting method, comprising:
S1: selecting a study area, determining control sections and controlling reservoirs, and acquiring and organizing long-series historical meteorological and hydrological data:
meteorological data of the control sections: A_{f}={a₁, a₂, a₃, . . . , aᵢ, . . . , a_{N}};
hydrological data of the control sections: H_{f}={h₁, h₂, h₃, . . . ,hᵢ, . . . ,h_{N}};
meteorological data of the controlling reservoirs: Aᵣ={b₁, b₂, b₃, . . . , bⱼ, . . . , b_{M}}; and
hydrological data of the controlling reservoirs: Hᵣ{l₁, l₂, l₃, . . . , lⱼ, . . . , l_{M}};
wherein, A_{f} denotes the meteorological data of the control sections; aᵢ denotes the meteorological data of an i-th control section; H_{f} denotes the hydrological data of the control sections; hᵢ denotes the hydrological data of the i-th control section; N denotes a number of the control sections; Aᵣ denotes the meteorological data of the controlling reservoirs; bⱼ denotes the meteorological data of a j-th controlling reservoir; Hᵣ denotes the hydrological data of the controlling reservoirs; lⱼ denotes the hydrological data of the j-th controlling reservoir; and M denotes a number of the controlling reservoirs;
S2: establishing a rainfall, runoff generation, confluence, and routing integrated chained-process forecasting framework, and performing series calculations through a meteorological rainfall module R(r₁, r₂, . . . , rₓ), a land surface runoff generation module Q(R, S, Pa, M), a river channel confluence module M (Q, L, G, X), and a runoff routing module E(M, L, G, O, Y);
wherein, R(r₁, r₂ . . . , rₓ) denotes a rainfall calculation equation, and rₓ denotes different factors affecting a rainfall value;
Q(R, S, Pa, M) denotes a runoff generation calculation equation; R denotes the rainfall value; S denotes a catchment area of a basin; Pa denotes an antecedent precipitation index; and M denotes a runoff generation mode, comprising saturation excess runoff generation and infiltration excess runoff generation;
M ((Q, L, G, X) denotes a confluence calculation equation; Q denotes a runoff generation value; L denotes a length of a confluence river channel; G denotes a slope of the confluence river channel; and X denotes a factor affecting confluence; and
E(M, L, G, O, Y) denotes a routing calculation equation; M denotes a confluence value; O denotes a regulation and storage impact of reservoirs during a routing process; and Y denotes a factor affecting routing;
S3: constructing a hybrid downscaling model R′ in the meteorological rainfall module, and performing medium-to-long-term rainfall forecasting in the study area;
S4: performing, by taking a rainfall forecast as an input in the land surface runoff generation module, runoff generation calculations for control sections corresponding to different zones in the study area through a hydrological model, assuming Sₘ is an m-th zone of the study area, with a runoff yield of Qₘ=Γ(Sₘ), wherein Γ(Sₘ) denotes a runoff generation calculation equation for the m-th zone;
S5: performing, by combining an isochrone method, a time-interval unit hydrograph method and an instantaneous unit hydrograph method, a river channel confluence calculation in the river channel confluence module to acquire discharge processes of different control sections;
S6: performing, by a Muskingum method, a composite discharge method and a hydrodynamic method, a river channel routing calculation in the runoff routing module to acquire discharge processes of different control sections after river channel routing;
S7: performing sequential routing calculations for each node from upstream to downstream according to a same time scale until runoff processes of the control sections at the same time scale are output; and
S8: completing runoff process calculations for the study area at different time scales, comprising ten-day, monthly, seasonal, and annual.

2. The atmosphere-land-reservoir-river integrated medium-to-long-term chained-process runoff forecasting method according to claim 1, wherein in the step S1, a method for determining the control sections and the controlling reservoirs comprises: selecting a section where an important flood control protection object is located and a concerned section as control sections, and selecting reservoirs with a flood control capacity greater than or equal to 100 million m³ or a total storage capacity ranking among top 5-10% of all reservoirs in the basin as controlling reservoirs, based on a condition of the flood control protection object in the study area, sections to be forecasted, and reservoirs with a large total storage capacity and a regulatory capacity in the basin, and on a premise of ensuring flood control safety of the basin.

3. The atmosphere-land-reservoir-river integrated medium-to-long-term chained-process runoff forecasting method according to claim 2, wherein
in the step S1, the meteorological data comprises rainfall, air temperature, wind speed, and radiation; and
the hydrological data comprises discharge, water level, evaporation, reservoir water level, reservoir inflow, and reservoir outflow.

4. The atmosphere-land-reservoir-river integrated medium-to-long-term chained-process runoff forecasting method according to claim 3, wherein in the step S3, the medium-to-long-term rainfall forecasting comprises: medium-term rainfall forecasting for taking ten-day as a calculation scale and outputting daily rainfall in an area above each control section; and long-term rainfall forecasting for taking monthly, seasonal, and annual as calculation scales and outputting monthly rainfall in the area above each control section.

5. The atmosphere-land-reservoir-river integrated medium-to-long-term chained-process runoff forecasting method according to claim 4, wherein in the step S3, the hybrid downscaling model refers to a medium-to-long-term rainfall forecasting model constructed by coupling dynamic downscaling, statistical downscaling, and artificial intelligence, and is configured to perform following steps:
S301: acquiring output data
$${R}_{out}^{k} ( k = 1 , 2 , … , K )$$
of different global climate models, wherein
$${R}_{out}^{k}$$
denotes rainfall output data of a k-th global climate model, and K denotes a number of types of global climate models participating in a calculation; comparing and analyzing the output data with measured data
$${R}_{{A}_{f}}^{k}$$
of the study area; evaluating forecasting accuracy P^{k} of different global climate models; and sorting availability of different global climate models in descending order of the forecasting accuracy, wherein
$${P}^{k} = \frac{{P}_{{A}_{f}}^{k} + {P}_{{A}_{r}}^{k}}{2} ;$$
P^{k} denotes the forecasting accuracy of the k-th global climate model;
$${P}_{{A}_{f}}^{k}$$
denotes the forecasting accuracy of the control section in the k-th global climate model; and
$${P}_{{A}_{r}}^{k}$$
denotes the forecasting accuracy of the controlling reservoir in the k-th global climate model;
S302: selecting one or multiple global climate models with high availability according to an evaluation result in combination with a characteristic of the study area; setting an initial condition and a boundary condition, and performing simulation operation; and acquiring a regional climate model with a good forecasting effect for the study area;
wherein, if one global climate model is selected, a calculation result
$${R}_{out}^{k ′}$$
of the regional climate model is equal to the output data
$${R}_{out}^{k}$$
of the global climate model; and
if multiple global climate models are selected, the calculation result
$${R}_{o u t}^{k ″}$$
of the regional climate model is equal to an arithmetic mean of calculation results of the multiple global climate models:
$${R}_{out}^{k ″} = \frac{{R}_{o u t}^{1} + {R}_{o u t}^{2} + … + {R}_{o u t}^{k}}{k} ;$$
S303: analyzing a simulation result, and evaluating an error in the global climate models; and fitting an error distribution law through an artificial intelligence algorithm based on deep learning, and acquiring an error correction calculation equation e(X), wherein e denotes error correction data; and X denotes a matrix comprising a factor affecting the error distribution law; and
S304: performing medium-to-long-term rainfall forecasting for the study area through the regional climate model; and revising a forecasting result based on the error correction calculation equation, and outputting the revised forecasting result as a final rainfall forecasting result,
$${R}_{o u t}^{a l l} = {R}_{out}^{k ′} + e .$$

6. The atmosphere-land-reservoir-river integrated medium-to-long-term chained-process runoff forecasting method according to claim 5, wherein in the step S4, the hydrological model comprises a Xinanjiang model, a rainfall-runoff correlation graph, a Sacramento (SAC) model, a soil and water assessment tool (SWAT) model, a topography-based model of landscape evolution (TOPMODEL), and a hydrological model suitable for a runoff calculation above the monthly scale;
the runoff generation calculations comprise: a medium-term runoff generation calculation within the ten-day scale: performing a calculation through the Xinanjiang model, the rainfall-runoff correlation graph, the SAC model, the SWAT model, and the TOPMODEL according to a climate zone and a runoff generation characteristic of the study area, and outputting a daily runoff forecast; and
a long-term runoff generation calculation at the monthly scale and above: performing a calculation through the SWAT model, the TOPMODEL, and the hydrological model suitable for the runoff calculation above the monthly scale, and outputting a monthly runoff forecast.

7. The atmosphere-land-reservoir-river integrated medium-to-long-term chained-process runoff forecasting method according to claim 6, wherein in the step S5, when the river channel confluence calculation is performed, the isochrone method is adopted in case of a non-uniform rainfall areal distribution in the study area;
the time-interval unit hydrograph method is adopted in case of a uniform rainfall spatiotemporal distribution during a calculation period and a short net rainfall duration; and
the instantaneous unit hydrograph method is adopted in case of an obvious runoff change process predicted during the calculation period and a uniformly distributed net rainfall intensity within a unit time interval.

8. The atmosphere-land-reservoir-river integrated medium-to-long-term chained-process runoff forecasting method according to claim 7, wherein in the step S6, when the river channel routing calculation is performed, the Muskingum method is adopted in case of a straight river channel and a linear discharge change along a course;
the composite discharge method is adopted in case of a short river channel routing length and many tributary inflows; and
the hydrodynamic method is adopted in case of a complex river channel terrain and a nonlinear discharge change along the course.

9. The atmosphere-land-reservoir-river integrated medium-to-long-term chained-process runoff forecasting method according to claim 1, comprising at least one processor and a memory communicatively connected to the at least one processor, wherein
the memory is configured to store an instruction executable by the processor; and the instruction is executed by the processor to implement the atmosphere-land-reservoir-river integrated medium-to-long-term chained-process runoff forecasting method.

10. The atmosphere-land-reservoir-river integrated medium-to-long-term chained-process runoff forecasting method according to claim 2, comprising at least one processor and a memory communicatively connected to the at least one processor, wherein
the memory is configured to store an instruction executable by the processor; and the instruction is executed by the processor to implement the atmosphere-land-reservoir-river integrated medium-to-long-term chained-process runoff forecasting method.

11. The atmosphere-land-reservoir-river integrated medium-to-long-term chained-process runoff forecasting method according to claim 3, comprising at least one processor and a memory communicatively connected to the at least one processor, wherein
the memory is configured to store an instruction executable by the processor; and the instruction is executed by the processor to implement the atmosphere-land-reservoir-river integrated medium-to-long-term chained-process runoff forecasting method.

12. The atmosphere-land-reservoir-river integrated medium-to-long-term chained-process runoff forecasting method according to claim 4, comprising at least one processor and a memory communicatively connected to the at least one processor, wherein
the memory is configured to store an instruction executable by the processor; and the instruction is executed by the processor to implement the atmosphere-land-reservoir-river integrated medium-to-long-term chained-process runoff forecasting method.

13. The atmosphere-land-reservoir-river integrated medium-to-long-term chained-process runoff forecasting method according to claim 5, comprising at least one processor and a memory communicatively connected to the at least one processor, wherein
the memory is configured to store an instruction executable by the processor; and the instruction is executed by the processor to implement the atmosphere-land-reservoir-river integrated medium-to-long-term chained-process runoff forecasting method.

14. The atmosphere-land-reservoir-river integrated medium-to-long-term chained-process runoff forecasting method according to claim 6, comprising at least one processor and a memory communicatively connected to the at least one processor, wherein
the memory is configured to store an instruction executable by the processor; and the instruction is executed by the processor to implement the atmosphere-land-reservoir-river integrated medium-to-long-term chained-process runoff forecasting method.

15. The atmosphere-land-reservoir-river integrated medium-to-long-term chained-process runoff forecasting method according to claim 7, comprising at least one processor and a memory communicatively connected to the at least one processor, wherein
the memory is configured to store an instruction executable by the processor; and the instruction is executed by the processor to implement the atmosphere-land-reservoir-river integrated medium-to-long-term chained-process runoff forecasting method.

16. The atmosphere-land-reservoir-river integrated medium-to-long-term chained-process runoff forecasting method according to claim 8, comprising at least one processor and a memory communicatively connected to the at least one processor, wherein
the memory is configured to store an instruction executable by the processor; and the instruction is executed by the processor to implement the atmosphere-land-reservoir-river integrated medium-to-long-term chained-process runoff forecasting method.
